(19) United States
(12) Patent Application Publication
(10) Pub. No.: US 2014/0223319 A1
(43) Pub. Date: Aug. 7, 2014

(54) SYSTEM, APPARATUS AND METHOD FOR PROVIDING CONTENT BASED ON VISUAL SEARCH

(71) Applicant: Yuki Uchida, Lincoln Park, NJ (US)

(72) Inventor: Yuki Uchida, Lincoln Park, NJ (US)

(21) Appl. No.: 13/758,326

(22) Filed: Feb. 4, 2013

(51) Int. Cl. G06F 17/30

(52) U.S. Cl. CPC G06F 17/30277
USPC 715/739

(57) ABSTRACT

Information technology tools can be provided to provide user access to content based on an image captured on a user device. One or more image objects are extracted from the captured image and are utilized, for example, along with the location of the user device, to perform a visual search in an image association database to retrieve and display content information corresponding to a matched image object.

### TECHNICAL FIELD

This disclosure relates to tools, such as, for example, systems, apparatuses, methodologies, computer program products, application software, etc., for providing content to a user, and more specifically, such tools for providing content based on visual search.

### BACKGROUND

In the current digital age, the trend is that information technology (IT) and digital media are more and more commonly used in everyday activities and are becoming prevalent in all aspects of life. For example, modern web-based search engines allow Internet users to search and retrieve from a tremendous amount of digital information available on the World Wide Web. A user can provide one or more keywords to a search engine via a web browser and in response, a list of web pages associated with the keywords is displayed through the web browser.

However, it is sometimes cumbersome for the user to access the search engine website and/or type in the keywords into the search field, such as, for example, when the user is on-the-go. Further, the user may find it difficult to come up with keywords that would return search results related to certain real world objects that the user wishes to learn more about.

There is a need for an improved method of searching for and accessing information.

### SUMMARY

In an aspect of this disclosure, there are provided tools (for example, a system, an apparatus, application software, etc.) to allow a user to obtain content based on an image captured on a terminal having an image capture function.

For example, such tools may be available through an application supplying apparatus (e.g., an application server) that supplies a content access application via a network to a user terminal, for user access to the content. The application can include a user interface provided on the user terminal to permit the user to invoke an image capture function that is present on the user terminal to capture an image, and add, as geo data associated with the captured image, location information indicating a current position of the user terminal as determined by a location determining function on the user terminal. Further, a content obtaining part of the application causes one or more image objects to be extracted (on the terminal-side, on the server-side, or by another image processing device) from the captured image and causes a visual search for the image object to be conducted in an image association database, to determine one or more associated items in the image association database that include image information matching the image object and that further include location information encompassing the geo data associated with the captured image. For each of the items, content information which is registered in connection with the item in the image association database is presented through the user interface for user selection, and upon user selection through the user interface of such content information, additional content corresponding to the content information is presented through the user interface.

In another aspect, the content obtaining part causes an outline of an image object to be extracted from the image and processed, and the visual search compares the processed outline of the image object to registered outlines in the image association database, and items in the image association database that have a registered outline that matches the outline of the image object are determined to match the image object.

In another aspect, the captured image is communicated to the application supplying apparatus, and the application supplying apparatus extracts image objects from the image, performs (or causes to be performed) a visual search in the image association database for the extracted image objects, and returns to the user terminal content information which is registered in the image association database in connection with matched image objects.

In another aspect, upon user selection, through the user interface, of selected content information registered in the image association database, multimedia content including a video can be presented.

In another aspect, content presented upon user selection, through the user interface, of selected content information registered in the image association database can be or include a coupon for obtaining a product or a service at a discounted charge.

In another aspect, an image object which is extracted from the captured image and for which a visual search is conducted in the image association database can be a company or product logo, word art, etc.

In another aspect, image processing (such as rotation, translation or another transformation) can be applied to the extracted image object, prior to visual search for the processed image object.

In another aspect, the captured image can include at least one of (i) a digital image of a real world scene and (ii) a digital image capturing a two-dimensional picture formed on a substantially flat surface of a structure.

In another aspect, the captured image is a digital image capturing a map of a predetermined area, and the image objects included in the captured image include graphical objects corresponding to respective locations of the area represented by the map.

In another aspect, the application supplied to the user terminal can include a usage tracking part that tracks and maintains usage data reflecting usage of the application on the user terminal, and the content presented through the user interface can be filtered or supplemented based on the usage data.

In another aspect, the application can be configured to communicate the captured image and the geo data via a network to an external apparatus, and to request the external apparatus to perform a visual search. In such case, the external apparatus retrieves content information which is registered in the image association database in connection with matched image objects and transmits the content information to the requesting application on the user terminal, to be provided through the user interface for user selection.

In another aspect, the content associated with a matched image object is stored by an external content source, and the content information which is registered in connection with the matched image object in the image association database and is provided through the user interface includes a resource locator to the content. Upon user selection of the content information, the resource locator is employed to retrieve the content from the external content source.

### BRIEF DESCRIPTION OF THE DRAWINGS

The aforementioned and other aspects, features and advantages can be better understood from the following detailed description with reference to the accompanying drawings wherein:

FIG. 1 shows a block diagram of a system, according to an exemplary embodiment;

FIG. 2 shows a block diagram of a system, according to another exemplary embodiment;

FIG. 3A shows a sample table for associating images to keywords, according to another exemplary embodiment;

FIG. 3B shows a sample table maintained for a specified keyword, according to another exemplary embodiment;

FIG. 3C shows a sample table for tracking usage, according to another exemplary embodiment;

FIG. 4 shows a block diagram of an exemplary configuration of a terminal, such as in the systems shown in FIGS. 1-3;

FIG. 5A shows an image showing a camera functionality of the terminal shown in FIG. 4, according to an exemplary embodiment;

FIG. 5B shows an image showing compass and GPS functionalities of the terminal shown in FIG. 4, according to an exemplary embodiment;

FIGS. 7A-7C show examples of the user interface displayed on a user's mobile device, according to an exemplary embodiment;

FIGS. 8A-8C show examples of the user interface displayed on a user's mobile device, according to an exemplary embodiment;

FIGS. 9A-9C show examples of the user interface displayed on a user's mobile device, according to an exemplary embodiment;

FIGS. 10A-10C show examples of the user interface displayed on a user's mobile device, according to an exemplary embodiment;

FIG. 11 shows an example of the user interface displayed on the user's mobile device, according to an exemplary embodiment;

FIG. 12A shows a work flow of a method for providing additional content to a user, according to an exemplary embodiment;

FIG. 12B shows a work flow of a method for providing additional content to a user, according to another exemplary embodiment;

FIG. 13A shows a work flow of a method for providing additional content to a user, according to another exemplary embodiment; and

FIG. 13B shows a work flow of a method for providing additional content to a user, according to another exemplary embodiment.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations will be omitted when it may obscure the subject matter of the present invention.

Referring now to the drawings, wherein like reference numerals designate identical or corresponding parts throughout the several views, there is described tools (systems, apparatuses, methodologies, computer program products, etc.) for providing additional content to a user, based on an image provided by the user.

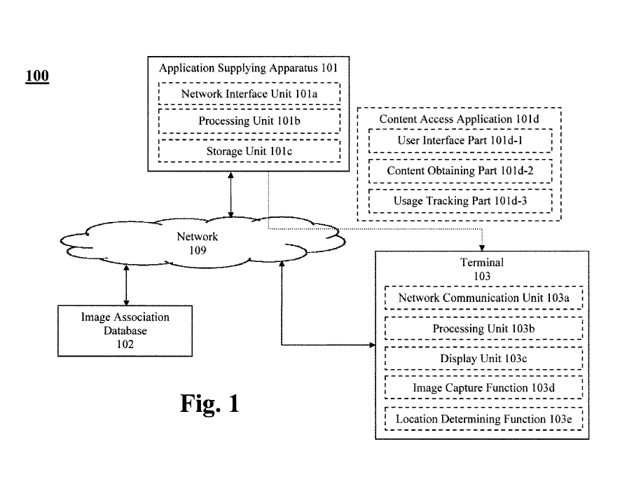

For example, FIG. 1 shows schematically a system 100 for providing additional content to a user, according to an exemplary embodiment. The system 100 includes an application supplying apparatus 101, an image association database 102 and a terminal 103, all of which are interconnected by a network 109.

The application supplying apparatus 101 comprises a network interface unit 101a, a processing unit 101b and a storage unit 101c.

The network interface unit 101a allows the application supplying apparatus 101 to communicate through the network 109, such as with the image association database 102 and the terminal 103. The network interface unit 101a is configured to communicate with any particular device amongst plural heterogeneous devices that may be included in the system 100 in a communication format native to the particular device. The network interface unit 101a may determine an appropriate communication format native to the particular device by any of various known approaches. For example, the network interface unit 101a may refer to a database or table, maintained internally or by an outside source, to determine an appropriate communication format native to the device. As another example, the network interface unit 101a may access an Application Program Interface (API) of the particular device, in order to determine an appropriate communication format native to the device.

The processing unit 101b carries out a set of instructions stored in the storage unit 101c by performing basic arithmetical, logical and input/output operations for the application supplying apparatus 101.

The storage unit 101c stores an application service program embodying a program of instructions executable by the processing unit 101b to supply a content access application 101d through the network interface unit 101a via the network 109 to the terminal 103, for user access to additional content.

The terminal 103 comprises a network communication unit 103a, a processing unit 103b, a display unit 103c, an image capture function 103d and a location determining function 103e.

The network communication unit 103a allows the terminal 103 to communication with other devices in the system 100, such as the application supplying apparatus 101.

The processing unit 103b executes the content access application 101d received from the application supplying apparatus 101. When the content access application 101d is executed by the processing unit 103b, the display unit 103c displays a user interface provided by the content access application 101d.

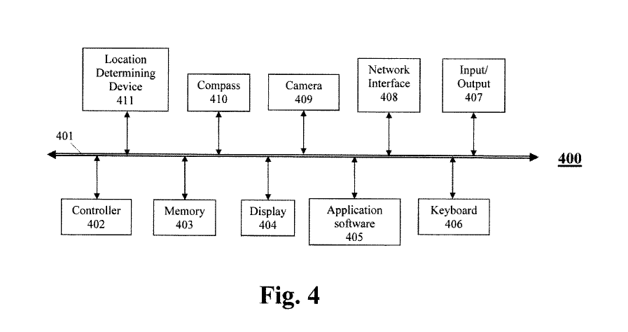

In addition, the image capture function 103d and the location determining function 103e are provided on the terminal 103. The terminal 103 may be equipped with a variety of functionalities such as a camera functionality, a location determining functionality (e.g. GPS) and a compass functionality, along with the software and hardware necessary to implement such functionalities (e.g. camera lenses, a magnetic sensor, a GPS receiver, drivers and various applications), which are further described infra in connection with FIG. 4. Thus, the content access application 103d provided by the application supplying apparatus 101 communicates with such software and hardware to allow the user at the terminal 103 to invoke the image capture function 103d and the location determining function 103e provided on the terminal 103.

The terminal 103 can be any computing device, including but not limited to a personal, notebook or workstation computer, a kiosk, a PDA (personal digital assistant), a mobile phone or handset, a tablet, another information terminal, etc., that can communicate with other devices through the network 109. Although only one terminal is shown in FIG. 1, it should be understood that the system 100 can include a plurality of terminals (which can have similar or different configurations). The terminal 103 is further described infra with reference to FIG. 4.

The content access application 101d provided to the terminal 103 includes a user interface part 101d-1, a content obtaining part 101d-2 and a usage tracking part 101d-3. The user interface part 101d-1 provides the user interface (e.g. by causing the user interface to be displayed by the display unit 103c) on the terminal 103. The displayed user interface permits the user at the terminal 103 to invoke an image capture function on the terminal 103 to capture an image including one or more image objects, and add, as geo data associated with the capture image, location information indicating a current position of the user terminal as determined by a location determining function on the terminal 103. The image capture function and the location determining function are further discussed infra in connection with FIG. 4.

In addition to the capturing of the image using the image capture function of the terminal 103, further processing may be performed on the captured image to put the captured image in the right condition for image object extraction. Such processing may utilize any known image perfection technologies which correct problems with camera angle, illumination, warping and blur.

The content obtaining part 101d-2 causes, for each particular image object amongst the one or more image objects included in the captured image, the particular image object to be extracted from the captured image.

In an exemplary embodiment, the content obtaining part 101d-2 of the content access application 101d may cause the processing unit 101b of the application supplying apparatus 101 to extract image objects included in the captured image by performing edge detection on the captured image to extract an outline of each of the image objects in the captured image. Conventional edge detection methods may be used to extract an outline of the particular image object from the captured image. For example, the processing unit 101b may select a pixel from the image portion of the captured image and sequentially compare the brightness of neighboring pixels, proceeding outward from the selected pixel. In doing so, if a particular adjacent pixel has a brightness value that is significantly greater or less than the selected pixel (e.g. exceeding a threshold value), the adjacent pixel may be determined to be an edge pixel delimiting an image object. Once all of such edge pixels are determined, the outline of the particular image object can be recognized. Such a process can be repeated until the processing unit 101b has examined all the pixels in the captured image to extract one or more outlines of the image objects from the captured image received from the terminal 103. However, the algorithm used by the processing unit 101b is not limited to the one discussed above, and any well-known detection methods not discussed herein (e.g. Canny algorithm) may be used to extract outlines of image objects from the captured image. Exemplary approaches for detecting and extracting image objects included in image data have been disclosed in the following patent references: U.S. Pat. No. 5,327,260 (Shimomae et al.); US 2011/0262005 A1 (Yanai).

In another exemplary embodiment, the processing unit 103b of the terminal 103 or the processing unit of another apparatus external to the terminal 103 may perform the outline extraction process.

In an exemplary embodiment, the captured image may include image objects that may have to be rotated before an outline of the image object can be extracted. For example, in FIG. 6, the image including the company name “Company A” is captured from the side. Thus, the image object is first rotated before the outline of the image object is extracted.

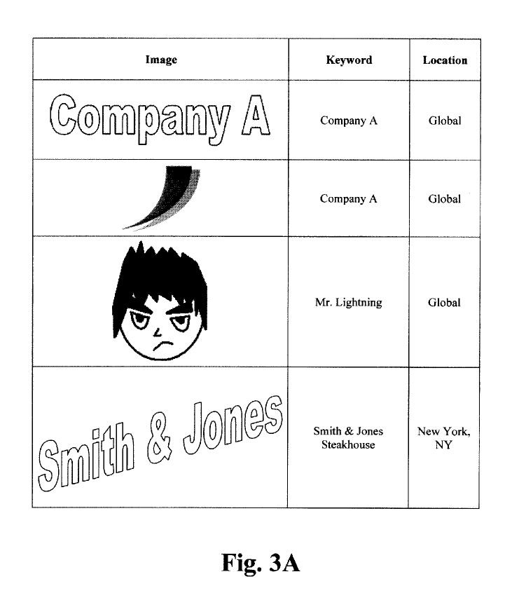

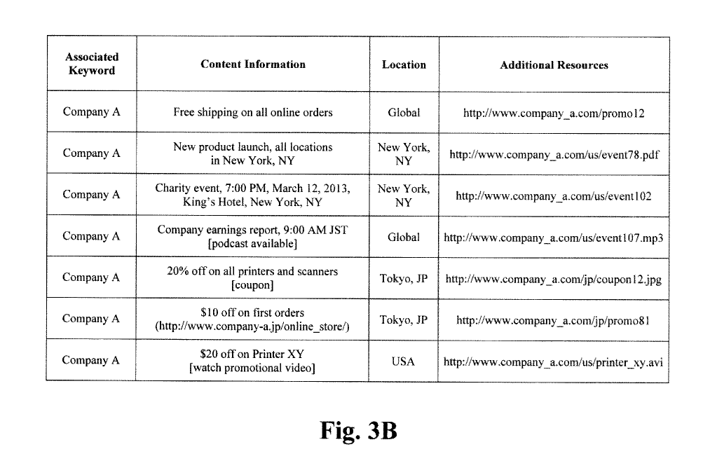

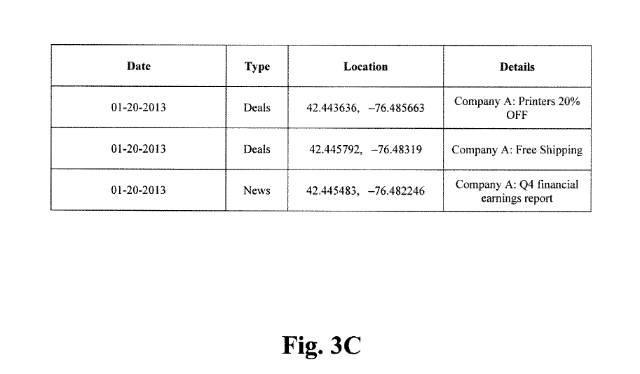

In an exemplary embodiment, image objects included in the captured image may include a human face, such as shown in FIG. 3A. In such a case, conventional facial recognition methods may be used to determine content information matching the image objects. For example, a facial recognition algorithm may analyze the relative position, size, and/or shape of the eyes, nose, cheekbones, and jaw. These features are then used to search for other images with matching features.

Once one or more image objects are extracted from the captured image, the content obtaining part 101d-2 causes a visual search for the extracted image objects to be conducted in an image association database, to determine one or more associated items in the image association database that include image information matching the image objects and that further include location information encompassing the geo data associated with the captured image.

For example, FIG. 3A shows a sample table associating a plurality of image objects with corresponding keywords and locations. For example, the first entry in the example of FIG. 3A is an image of a company's name “Company A”. The image is associated with the name of the company “Company A” and the relevant location of the company (“global”). The second entry is a company logo of “Company A”. The image of the company logo is associated with the name of the company “Company A” and the relevant location of the company (“global”). The third entry shows an image of a celebrity (e.g. a rock musician), which is associated with the name of the person (“Mr. Lightning”) and the relevant location (“global”). The fourth entry shows an image of a restaurant's name (“Smith & Jones”), which is associated with the name of the restaurant (“Smith & Jones Steakhouse”) and the relevant location of the restaurant (“New York, N.Y.”). For example, if a capture image provided by the user resembles the name “Smith & Jones” but is submitted from a location in France, there may not be a match between such captured image and the fourth entry shown in the example of FIG. 3A due to the difference in location.

The comparison of the location data determined by the location determining function of the terminal 103 and the location information stored in the image association database 102 can be done by utilizing any convention reverse geocoding algorithms. For example, if the location data is in the form of GPS coordinates, the location information (e.g. street address) corresponding to such coordinates can be interpolated from the range of coordinate values assigned to the particular road segment in a reference dataset (which, for example, contains road segment information and corresponding GPS coordinate values) that is closest to the location indicated by the GPS coordinates. If the GPS coordinates point to a location near the midpoint of a segment that starts with address 1 and ends with 100, the returned street address, for example, will be near 50. Alternatively, any public reverse geocoding services available through APIs and other web services may be used.

The location information obtained in the manner described above may then be compared to the location information stored in the image association database 102, to determine whether the obtained location information is encompassed by the location information stored in the image association database 102.

The images may be registered in the image association database by an administrator of the system, by individual corporate users of the system who wish to register images in order to facilitate advertising, marketing or any other business objectives that they may have, or by any other users of the content access application. For example, a singer may register a picture of himself or herself along with a keyword (e.g. his or her name) and/or location information in order to reach out to potential fans. Such registration feature may be provided, for example, by a web application accessible via a web browser.

Using the table such as shown in FIG. 3A, the visual search is performed to determine one or more keywords associated with the captured image provided by the user.

For example, the visual search may utilize any of a variety of image comparison algorithms. For example, the images can be compared using a block-based similarity check, wherein the images are partitioned into blocks of a specified pixel size. The color value of each of these blocks is calculated as the average of the color values of the pixels the block contains. The color value of each block of one image is checked against the color value of each block of the other image, keeping track of the percent similarity of the color values. For example, if the overall similarity is above a predetermined value, it is determined that the images match. In another exemplary embodiment, a keypoint matching algorithm [e.g. scale-invariant feature transform (SIFT)] may be used, where important features in one image, such as edges and corners, are identified and compared to those in the other image. Similarly, depending on the percent similarity of the features, whether the images match is determined. Exemplary approaches for performing image comparison have been disclosed in the following commonly-owned patents: U.S. Pat. No. 7,702,673 to Hull et al.; AND U.S. Pat. No. 6,256,412 to Miyazawa et al.

After one or more items (e.g. keywords) associated with the particular image object are determined, content information registered with the one or more items associated with the particular image object is presented to the user through the user interface for user selection.

FIG. 3B shows a sample table stored in an image association database, according to an exemplary embodiment. As shown in FIG. 3B, a particular keyword (“Company A”) is associated with various content information, location and additional resources. For example, in a case that the particular image object included in the captured image is determined to be a company logo of “Company A”, the table such as shown in FIG. 3B may be accessed to retrieve the content information registered with “Company A”. As shown in FIG. 3B, the content information registered with the particular keyword may include deals, meetings, events and any other information relevant to the particular keyword. In addition, each entry is associated with the location relevant to the content information. As shown in FIG. 3B, some content information may be applicable regardless of the location of the user (e.g. free shipping on all online orders), but other deals or events may be relevant only to users at a specific location (e.g. charity event in New York, N.Y. or deals that are applicable only in Japan). The location information may also be in the form of a zip code or GPS coordinates.

The content information displayed to the user via the user interface indicates the additional content that may be available. For example, if a set of directions for getting to a local office of Company A is registered in the database, the particular content information displayed to the user which corresponds to the directions may indicate that, upon selecting the displayed content information, directions to the local office of Company A would be displayed.

In the example of FIG. 3B, each entry in the table includes additional resource locator in the form of a uniform resource locator (URL). When the user selects particular content information displayed on the user terminal, additional content corresponding to the selected content information are retrieved using the resource locator. The retrieved additional content is displayed to the user via the user terminal. For example, if the user selects the content information “$20 off on Printer XY” via the user interface, the content obtaining part 101d-2 may employ the resource locator corresponding to the content information (“http://www.company_a.com/us/printer_xy.avi”) to retrieve an additional content (e.g. a promotional video featuring the Printer XY manufactured by Company A) from an external content source. The resource locator may also point to the website at which the particular deal may be available. Alternatively, the additional content available at the external content source may include a couple code for redeeming the particular deal or additional information regarding the particular deal.

The additional content provided to the user is not limited to those discussed in the present disclosure, and may include any multimedia content such as images and videos, maps and directions, coupons for obtaining a product or a service at a discounted charge, and so forth.

The usage tracking part 101d-3 tracks and maintains usage data reflecting usage of the application on the user terminal. Based on such usage data, the content obtaining part 101d-2 filters the additional content presented to the user through the user interface.

FIG. 3C shows a sample table for tracking the usage data of the user, according to an exemplary embodiment. As shown in FIG. 3C, the usage data maintained by the application may include the date of use, the type of content accessed, the location from which the user accessed the content, and details regarding the accessed content.

For example, if the particular user has often accessed deals offered by various companies in New York, N.Y., the application may present to the user one or more deals that may not be directly relevant to the image captured by the user but may interest the user, based on the usage data maintained for the user.

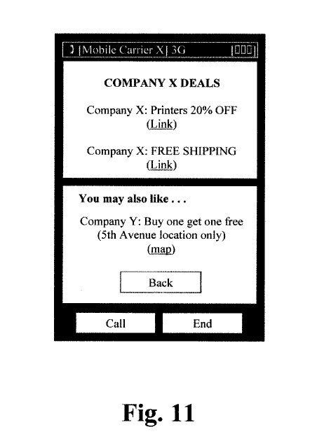

As shown in FIG. 11, although the user has originally found the deals offered by Company X, based on the previous user activity, the application has supplemented the content displayed to the user by including to the list deals offered by another company (“Company Y”). Alternatively, the usage data may cause the results displayed to the user to be filtered.

The image association database 102 contains content information registered in association with image objects and location information, for example, as shown in FIG. 3A. The image association database 102 may include a server for providing database services to the application supplying apparatus 101 and/or the content access application 101d. Such image association database 102 is utilized by the application supplying apparatus 101 and/or the content access application 101d to conduct the visual search, to retrieve matching content information based on the image objects extracted from the image captured by the image capture function 103d and the location data determined by the location determining function 103e.

In addition, the image association database 102 may store any captured images uploaded by the terminal 103, the additional contents associated the content information and/or any other data collected by the application supplying apparatus 101. Although the image association database 102 is shown in the example of FIG. 1 as being externally connected to the application supplying apparatus 101 via the network 109, the image association database 102 may be internal to the application supplying apparatus 101 or directly connected to the application supplying apparatus 101. The information may be stored in one or more databases [e.g. off-the-shelf database applications based on SQL (Structured Query Language), or other customized database applications with search/query function]. If the information is stored in more than one location, the information may be synced, for example, periodically or upon a user request.

The network 109 can be a local area network, a wide area network or any type of network such as an intranet, an extranet (for example, to provide controlled access to external users, for example through the Internet), the Internet, a cloud network (e.g. a public cloud which represents a network in which a service provider makes resources, such as applications and storage, available to the general public over the Internet, or a virtual private cloud which is a private cloud existing within a shared or public cloud), etc., or a combination thereof. Further, other communications links (such as a virtual private network, a wireless link, etc.) may be used as well for the network 109. In addition, the network 109 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

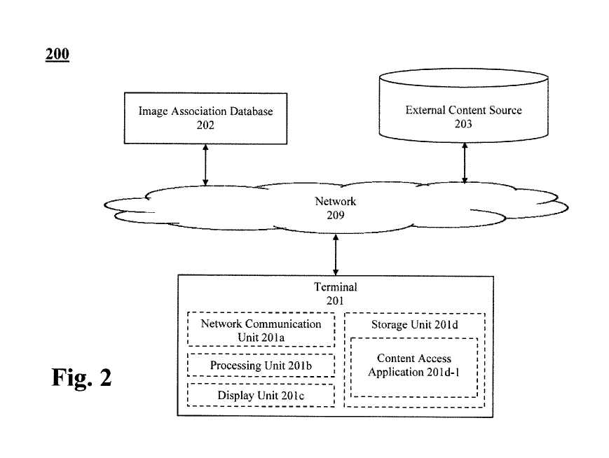

With reference to FIG. 2, a system for providing additional content to a user, according to another exemplary embodiment is described below.

FIG. 2 shows a block diagram of a system 200 which includes a terminal 201, an image association database 202 and an external content source 203, all of which are interconnected by a network 209.

The terminal 201 includes a network communication unit 201a, a processing unit 201b, a display unit 201c and a storage unit 201d, which includes a content access application 201d-1.

The system 200 differs from the system 100 of FIG. 1 in that the content access application 201d-1 is stored in the storage unit 201d, and when the content access application 201d-1 is executed by the processing unit 201b, a user interface for the content access application 201d-1 is displayed by the display unit 201c. Thus, the processing for extracting image objects from the captured image is performed by the processing unit 201b of the terminal 201.

The image association database 202 is accessible by the terminal 201 via the network 209 to perform the visual search to retrieve matching content information based on the image objects extracted from the captured image and the location data determined by the location determining function of the terminal 201. Based on the user selection of the content information, the content access application 201d-1 obtains additional content from the external content source 203.

Otherwise, the operations of the elements of the system 200 are similar to those of the system 100 of FIG. 1.

An example of a configuration of the terminals 103 and 201 of FIGS. 1 and 2 is shown schematically in FIG. 4. In FIG. 4, terminal device 400 includes a controller (or central processing unit) 402 that communicates with a number of other components, including memory 403, display 404, application software 405, keyboard (and/or keypad) 406, other input/output (such as mouse, touchpad, stylus, microphone and/or speaker with voice/speech interface and/or recognition software, etc.) 407, network interface 408, camera 409, compass 410 and location determining device 411, by way of an internal bus 401.

The memory 403 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 408 provides a connection (for example, by way of an Ethernet connection or other network connection which supports any desired network protocol such as, but not limited to TCP/IP, IPX, IPX/SPX, or NetBEUI) to a network (e.g. network 109 of FIG. 1).

Application software 405 is shown as a component connected to the internal bus 401, but in practice is typically stored in storage media such as a hard disk or portable media, and/or received through the network 109, and loaded into memory 403 as the need arises. The application software 405 may include applications for utilizing other components connected to the internal bus 401, such as a camera application or a compass application.

The camera 409 is, for example, a digital camera including a series of lenses, an image sensor for converting an optical image into an electrical signal, an image processor for processing the electrical signal into a color-corrected image in a standard image file format, and a storage medium for storing the processed images.

The series of lenses focus light onto the sensor [e.g. a semiconductor device such as a charge-coupled device (CCD) image sensor or a complementary metal-oxide-semiconductor (CMOS) active pixel sensor] to generate an electrical signal corresponding to an image of a scene. The image processor then breaks down the electronic information into digital data, creating an image in a digital format. The created image is stored in the storage medium (e.g. a hard disk or a portable memory card).

The camera 409 may also include a variety of other functionalities such as optical or digital zooming, auto-focusing and HDR (High Dynamic Range) imaging.

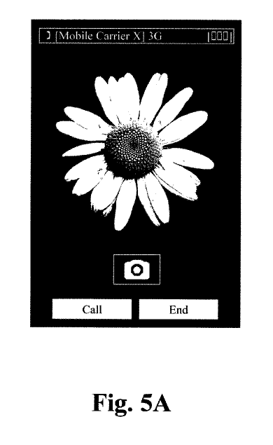

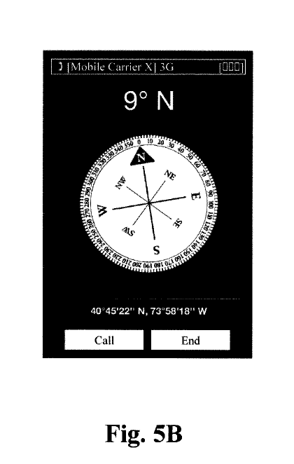

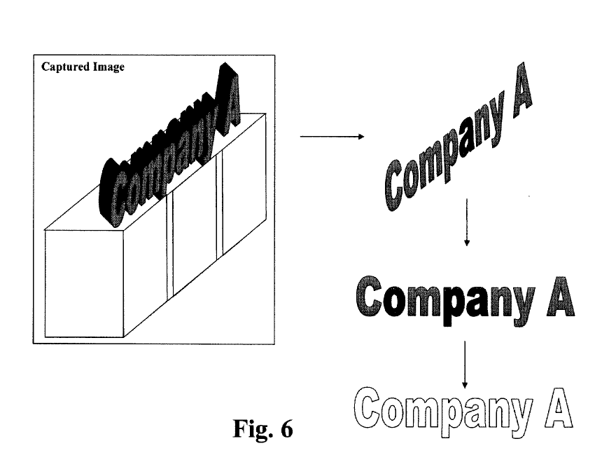

FIG. 5A shows an example of the camera function on a mobile device.

As shown in FIG. 5A, the camera captures an image of what is in front of it. Here, the camera lens of the mobile device is aimed at a flower. When the user of the mobile device presses the shutter (the box with a camera icon), the current image will be captured and stored as an image file on the mobile device.

The compass 410 is used to generate a directional orientation of the terminal device 400. That is, if the terminal device 400 is held such that it faces a certain direction, the compass 410 generates one particular reading (e.g. 16° N), and if the terminal device 400 is turned to face another direction without changing its location, the compass 410 generates another reading different from the earlier one (e.g. 35° NE).

The compass 410 is not itself an inventive aspect of this disclosure, and may be implemented in any of various known approaches. For example, the compass may include one or more sensors for detecting the strength or direction of magnetic fields, such as by being oriented in different directions to detect components of the Earth's magnetic field in different directions and determining a total magnetic field vector, thereby determining the orientation of the terminal device 400 relative to the Earth's magnetic field.

In another exemplary embodiment, the compass 410 may be implemented using a gyroscope (a spinning wheel whose axle is free to take any orientation) whose rotation interacts dynamically with the rotation of the earth so as to make the wheels precess, losing energy to friction until the axis of rotation of the gyroscope is parallel with the Earth's rotation.

In another exemplary embodiment, a GPS receiver having two antennas, which are installed some fixed distance apart, may be used as the compass 410. By determining the absolute locations of the two antennas, the directional orientation (i.e. from one antenna to the other) of the terminal device 400 can be calculated.

The configuration of the compass 410 is not limited to the aforementioned implementations and may include other means to determine the directional orientation of the terminal device 400.

The location determining device 411 determines a physical location of the terminal device 400. For example, the location determining device 411 may be implemented using a GPS receiver configured to receive signals transmitted by a plurality of GPS satellites and determine the distance to each of the plurality of GPS satellites at various locations. Using the distance information, the location determining device 411 can deduce the physical location of the terminal device 400 using, for example, triangulation.

In another exemplary embodiment, a similar deduction of the physical location can be made by receiving signals from several radio towers and calculating the distance from the terminal device 411 to each tower.

The configuration of the location determining device 411 is not limited to the aforementioned implementations and may include other means to determine the physical location of the terminal device 400.

FIG. 5B shows an example of the compass and GPS function on a mobile device.

As shown in FIG. 5B, a degree (“9°”) and a direction (“N”) are displayed to show to which direction the mobile device is being pointed. In addition, the GPS coordinates (“40° 45′22″ N, 73° 58′18″W”) of the mobile device is displayed at the bottom of the screen. The GPS coordinates correspond to a live location of the mobile device, and thus the coordinates are updated as the user moves the location of the mobile device.

Depending on the type of the particular terminal device, one or more of the components shown in FIG. 4 may be missing or connected externally. For example, a particular mobile phone may be missing the keyboard 406, but another keyboard may be connected to the mobile phone externally. Similarly, a particular desktop computer may, for example, have an external camera device (similar to the camera 409 described above) connected thereto.

Additional aspects or components of the terminal device 400 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

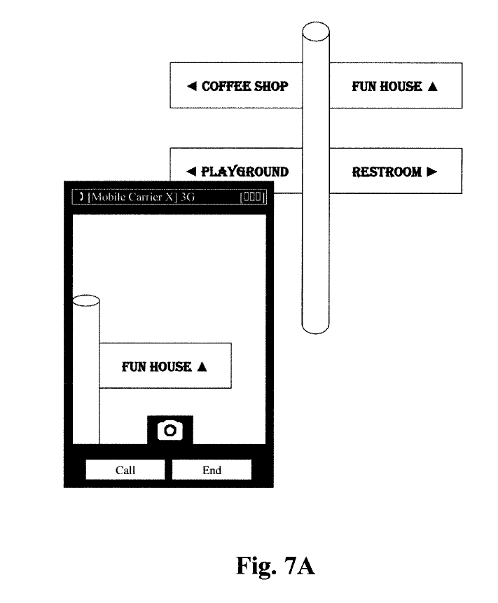

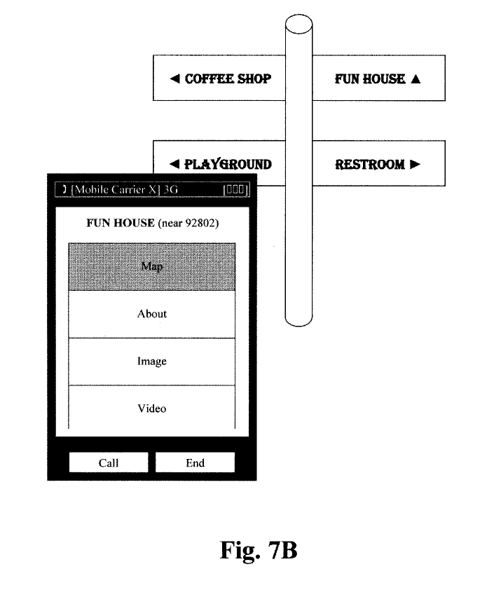

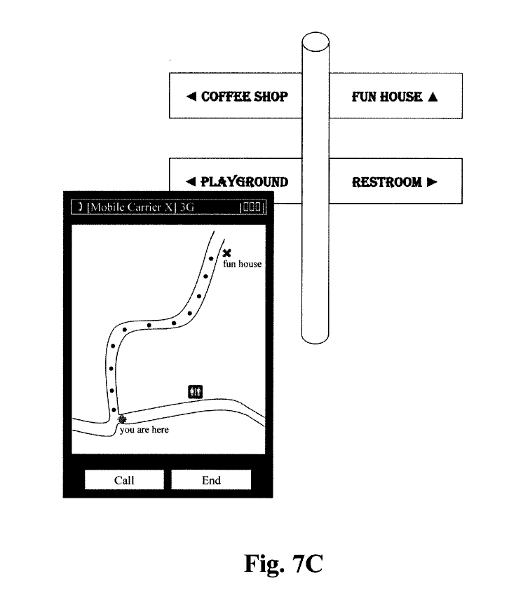

With reference to FIGS. 7-11 illustrate examples of the user interface displayed to the user at the terminal (e.g. a mobile device).

FIG. 7A shows the user taking a picture of the signpost, for example, at an amusement park. Upon taking the picture as shown in FIG. 7A, the application extracts the image object included in the captured image (“fun house”) and determines the location of the mobile device (“92802”). Using the image object and the determined location, a visual search is conducted and the content information (e.g. “map”, “about”, “image” and “video”) such as shown in FIG. 7B is displayed to the user. When the user selects one of the content information displayed on the screen, additional content corresponding to the selected content information is further presented to the user. For example, in the example of FIG. 7B, the “map” button is selected by the user, and consequently, a map showing the location of “fun house” (e.g. along with how to get to the location from the current location of the user) is displayed to the user, as shown in FIG. 7C. The compass function of the mobile device may be used to orient the map in the viewing direction of the user.

In another exemplary embodiment, the application may suggest to the user, based on the captured image and the location of the mobile device, the next attraction that the user should visit.

Also, in another exemplary embodiment, the example shown in FIGS. 7A-7C may be used as part of a game (e.g. scavenger hunt, treasure hunt, etc.) in which the participants are given clues based on the captured image and the location of the user, the clues eventually leading the user to the final destination or the objective of the game.

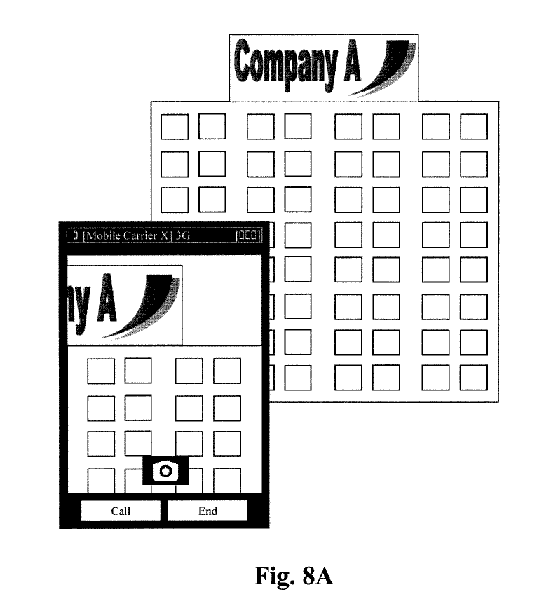

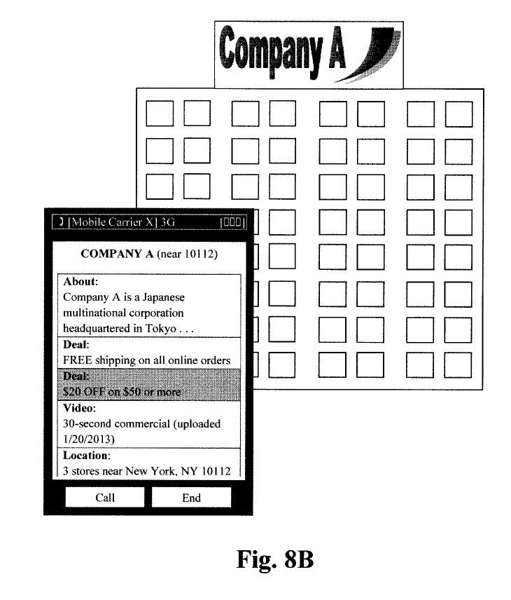

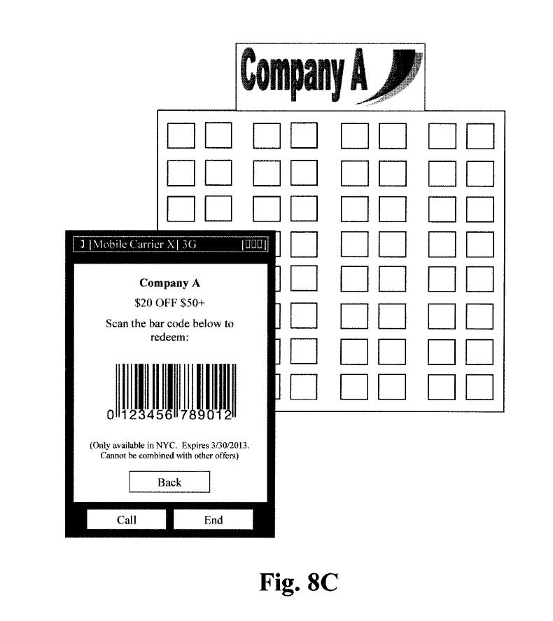

FIG. 8A shows the user taking a picture of a company logo displayed at the top of a building. Upon taking the picture as shown in FIG. 8A, the application extracts the image object included in the captured image (the company logo) and determines the location of the mobile device (“10112”). Using the image object and the determined location, a visual search is conducted and the content information (e.g. “about”, “deal”, “video” and “location”) such as shown in FIG. 8B is displayed to the user. In the example of FIG. 8B, more detail is provided for each piece of content information displayed on the screen. As shown in FIG. 8B, when the user selects one of the content information (e.g. “Deal: $20 OFF on $50 or more”), additional content (which is in this case a bar code to be scanned at the store to redeem the deal) is presented to the user via the mobile device, such as shown in FIG. 8C. For example, the use of the bar code may be tracked by the company offering the deal, and thus the effectiveness of the marketing can be measured.

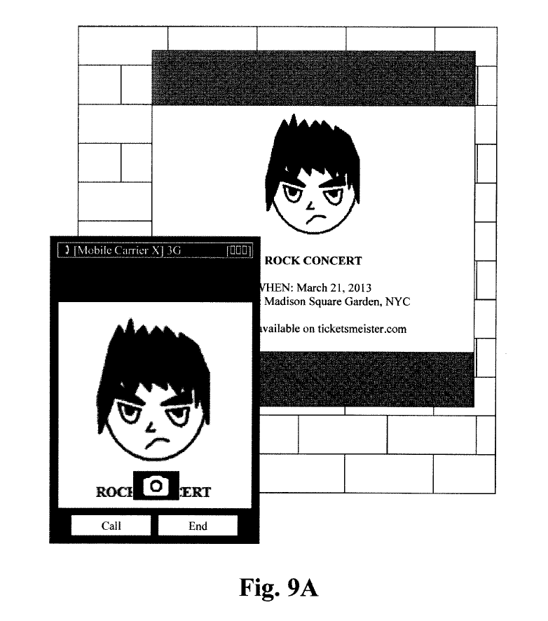

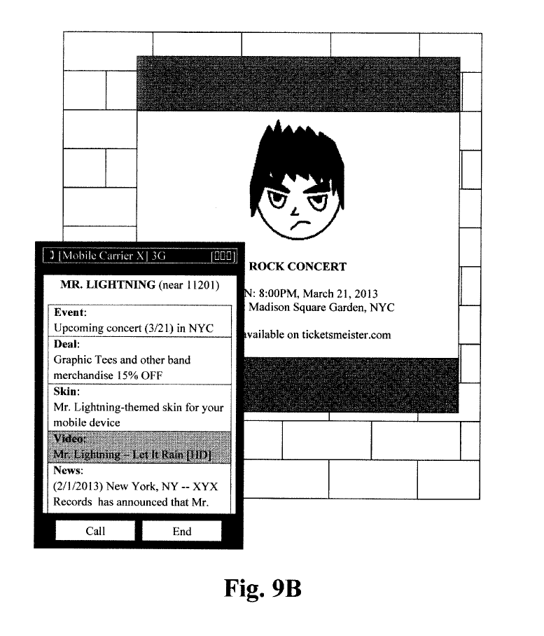

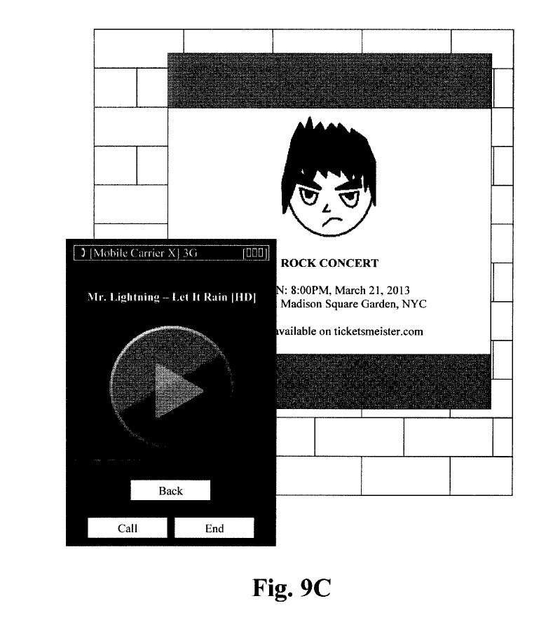

FIG. 9A shows another example in which the user captures the image of a celebrity figure included in a concert poster. When the user takes the picture as shown in FIG. 9A, the application extracts the image object included in the captured image (the face of the person) and determines the location of the mobile device (“11201”). Using the image object and the determined location, a visual search is conducted and the content information (e.g. “event”, “deal”, “skin” for customizing the appearance of the user interface on the mobile device to a particular theme, “video” and “news”) such as shown in FIG. 9B is displayed to the user. As shown in FIG. 9B, when the user selects one of the content information (e.g. “Video: Mr. Lightning—Let It Rain [HD]”), additional content (which is a video of a song played by “Mr. Lightning”) is presented to the user via the mobile device, such as shown in FIG. 9C.

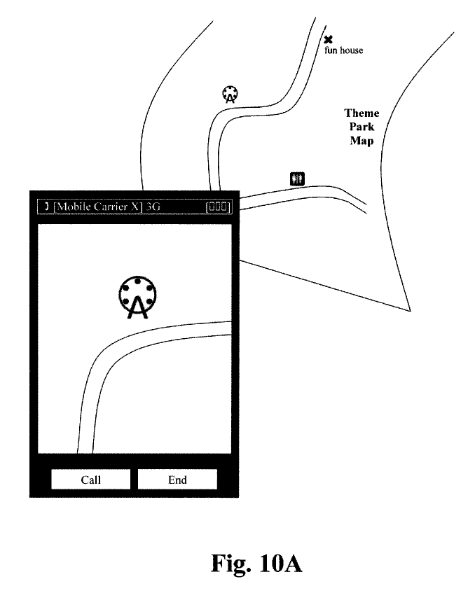

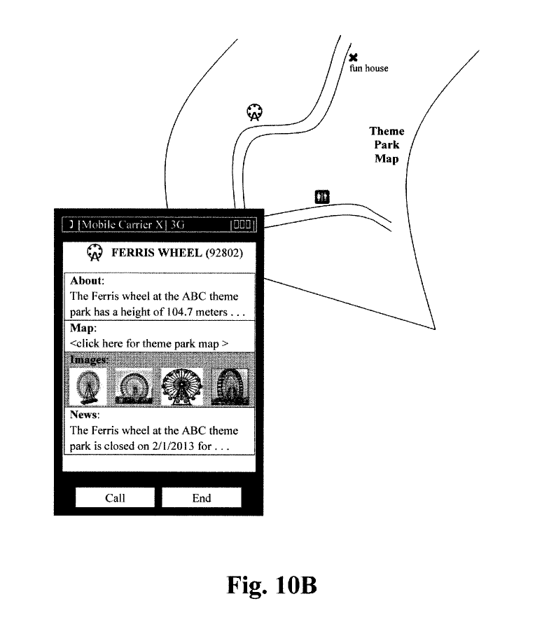

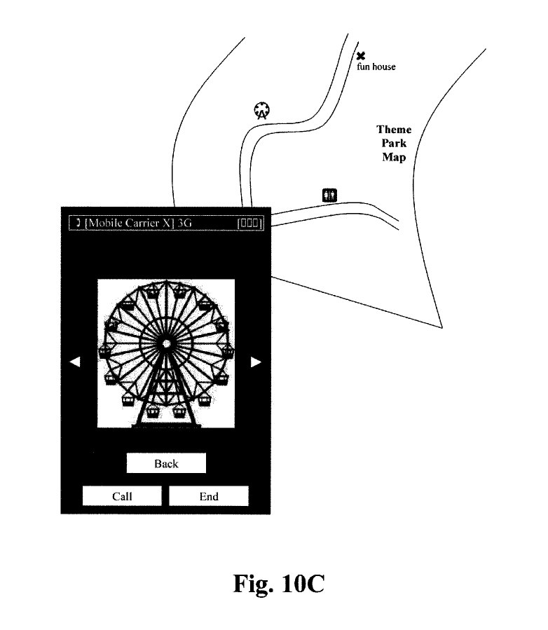

FIG. 10A shows another example in which the user captures the image of a map of a predetermined area (e.g. a theme park map). When the user takes the picture of a certain portion of the map as shown in FIG. 10A, the application extracts the image object included in the captured image (e.g. the icon representing a Ferris wheel) and determines the location of the mobile device (“92802”). In a case that the captured image contains more than one image object, the user may be presented with all the image objects (e.g. image objects representing the Ferris wheel, bumper car, restroom, park entrance, etc.) extracted from the captured image (e.g. along with their corresponding keywords) and asked to select one of the image objects about which the user wishes to obtain more information.

Using the image object and the determined location, a visual search is conducted and the content information (e.g. “about”, “map”, “images” and “news”) such as shown in FIG. 10B is displayed to the user. As shown in FIG. 10B, when the user selects one of the content information (e.g. images associated with the identified object “Ferris wheel at the ABC park”), additional content (e.g. an image of the Ferris wheel at the ABC park) is presented to the user via the mobile device, such as shown in FIG. 10C.

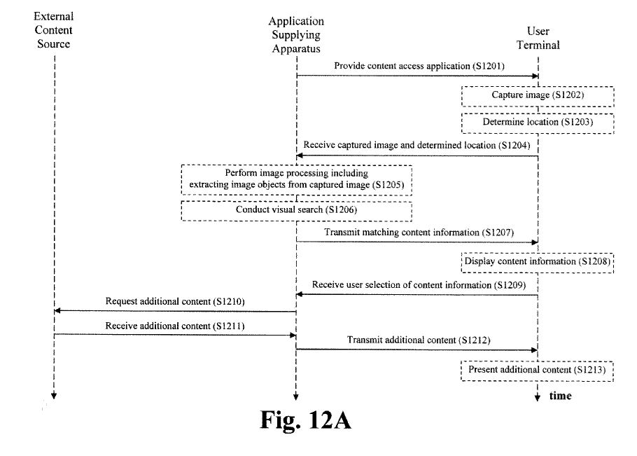

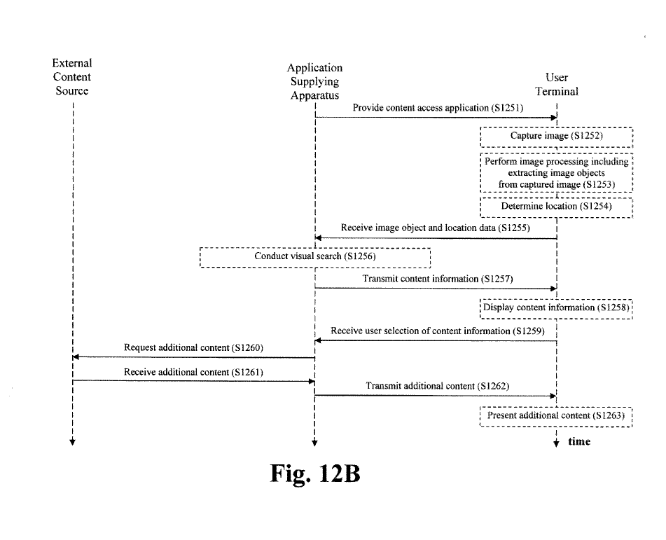

With reference to FIG. 12A, a method for providing additional content to a user, according to an exemplary embodiment, is described.

In 51201, the application supplying apparatus provides a content access application to the user terminal. The content access application causes an image to be captured (step S1202) and the location of the user terminal to be determined (step S1203), and transmits the captured image and the location data to the application supplying apparatus (step S1204). Upon receiving the captured image and the location data, the application supplying apparatus performs image processing on the captured image, including, but not limited to, extracting one or more image objects from the captured image (step S1205) and conducts a visual search to determine matching content information, using the one or more extracted image objects and the location data received from the user terminal (step S1206). When the matching content information is determined by the visual search conducted, for example, in an image association database, the matching content information is transmitted (step S1207) and displayed to the user at the user terminal for user selection (step S1208). Upon receiving the user selection of the content information (step S1209), the application supplying apparatus requests additional content from an external content source (which may store various types of data including videos, images, documents, etc.), based on the selected content information (e.g. using the resource locator associated with the selected content information) (step S1210). When the requested additional content is received from the external content source (step S1211), the application supplying apparatus transmits the received additional content to the user terminal (step S1212) to be presented to the user (step S1213).

With reference to FIG. 12B, a method for providing additional content to a user, according to another exemplary embodiment, is described.

In the example of FIG. 12B, the image processing on the captured image is performed by the user terminal, rather than the application supplying apparatus, as shown in FIG. 12A. Thus, after the application supplying apparatus provides a content access application to the user terminal (step S1251), the content access application causes an image to be captured (step S1252), image processing to be performed on the captured image (e.g. including extracting one or more image objects from the captured image) (step S1253) and the location of the user terminal to be determined (step S1254), and transmits the extracted image objects and the location data to the application supplying apparatus (step S1255). Upon receiving the captured image and the location data, the application supplying apparatus conducts a visual search to determine matching content information, using the one or more image objects and the location data received from the user terminal (step S1256). When the matching content information is determined by the visual search conducted, for example, in an image association database, the matching content information is transmitted (step S1257) and displayed to the user at the user terminal for user selection (step S1258). Upon receiving the user selection of the content information (step S1259), the application supplying apparatus requests additional content from an external content source (which may store various types of data including videos, images, documents, etc.), based on the selected content information (e.g. using the resource locator associated with the selected content information) (step S1260). When the requested additional content is received from the external content source (step S1261), the application supplying apparatus transmits the received additional content to the user terminal (step S1262) to be presented to the user (step S1263).

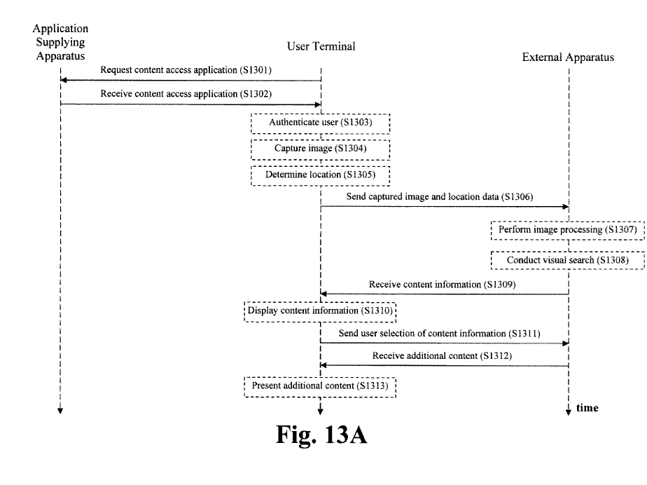

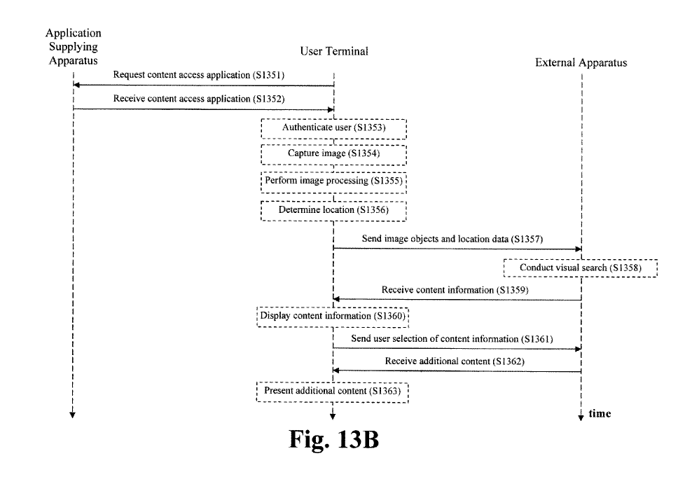

With reference to FIG. 13A, a method for providing additional content to a user, according to another exemplary embodiment, is described.

Upon receiving a request for a content access application from the user terminal (step S1301), the application supplying apparatus sends the content access application to the user terminal (step S1302). When the content access application is initialized, the content access application authenticates the user at the user terminal, for example, by requesting login credentials from the user to verify the identity of the user (step S1303). Upon successful authentication, the content access application causes an image to be captured (step S1304), and the location of the user terminal to be determined (S1305). The application sends the captured image and the location data to an external apparatus (step S1306) to cause the external apparatus to perform image processing on the captured image (step S1307) and to conduct a visual search based on the one or more image objects extracted during the image processing and the location data (step S1308). The application running on the user terminal receives the matching content information transmitted by the external apparatus (step S1309) and displays the content information to the user at the user terminal for user selection (step S1310). When the user selects one of the displayed content information, the selected content information is transmitted to the external apparatus (step S1311), and the additional content (e.g. video, audio, image, document, etc.) received in return from the external apparatus (step S1312) is presented to the user at the user terminal (step S1313).

With reference to FIG. 13B, a method for providing additional content to a user, according to another exemplary embodiment, is described.

In the example of FIG. 13B, the image processing on the captured image is performed by the user terminal, rather than an external apparatus, as illustrated in FIG. 13A. Thus, after the content access application is requested (step S1351) and received from the application supplying apparatus (step S1352), the content access application authenticates the user at the user terminal (step S1353), causes an image to be captured (step S1354), image processing to be performed on the captured image (step S1355), and the location of the user terminal to be determined (S1356). The application sends one or more image objects extracted from the captured image during the image processing and the location data to an external apparatus (step S1357) to cause the external apparatus to conduct a visual search based on the one or more image objects and the location data (step S1358). The application receives the matching content information transmitted by the external apparatus (step S1359) and displays the content information to the user at the user terminal for user selection (step S1360). When the user selects one of the displayed content information, the selected content information is transmitted to the external apparatus (step S1361), and the additional content (e.g. video, audio, image, document, etc.) received in return from the external apparatus (step S1362) is presented to the user at the user terminal (step S1363).

Thus, in the aforementioned aspects of the present disclosure, instead of having to come up with keywords that would return search results that the user wishes to obtain, the user can simply take a picture of what he or she wishes to learn more about (e.g. using his or her handset), and additional content relevant to the picture is provided to the user.

The aforementioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

What is claimed is:

1. An application supplying apparatus comprising a network interface unit for communicating through a network, a processing unit and a storage unit storing an application service program embodying a program of instructions executable by the processing unit to supply a content access application through the network interface unit via the network to a user terminal having a network communication unit, for user access to additional content, wherein said application supplied by said application supplying apparatus via the network to the user terminal comprises:
a user interface part that provides a user interface on the user terminal, to permit the user to invoke an image capture function on the user terminal to capture an image including one or more image objects, and add, as geo data associated with the captured image, location data indicating a current position of the user terminal as determined by a location determining function on the user terminal; and
a content obtaining part that, for each particular image object amongst said one or more image objects, (i) causes the particular image object to be extracted from the captured image and causes a visual search for the particular image object to be conducted in an image association database, to determine one or more associated items in the image association database that include image information matching the particular image object and that further include location information encompassing the geo data associated with the captured image, (ii) presents, for each particular item of the one or more associated items, content information which is registered in connection with the particular item in the image association database, through the user interface for user selection, and (iii) upon receiving the user selection through the user interface of said content information registered in connection with the particular item in the image association database, presenting, through the user interface, additional content corresponding to the content information.

2. The application supplying apparatus of claim 1, wherein
the content obtaining part causes an outline of the particular image object to be extracted from the image and processed, and the visual search compares the processed outline of the particular image object to registered outlines in the image association database, and wherein
the one or more associated items in the image association database that are determined to match the particular image object have a registered outline that matches the processed outline of the particular image object.

3. The application supplying apparatus of claim 1, wherein
the content obtaining part causes the captured image to be communicated to the application supplying apparatus, to trigger the processing unit of the application supplying apparatus to extract the particular image object from the captured image, perform the visual search for the particular image object in the image association database, and return to the user terminal the content information which is registered in connection with the particular item in the image association database.

4. The application supplying apparatus of claim 1, wherein the additional content presented upon the user selection through the user interface of said content information registered in connection with the particular item in the image association database is multimedia content including a video.

5. The application supplying apparatus of claim 1, wherein the additional content presented upon the user selection through the user interface of said content information registered in connection with the particular item in the image association database includes a coupon for obtaining a product or a service at a discounted charge.

6. The application supplying apparatus of claim 1, wherein at least one of the image objects in the captured image for which the visual search is conducted in the image association database is a company logo or product logo.

7. The application supplying apparatus of claim 1, wherein
the particular image object extracted from the captured image is word art, and image processing is applied to rotate the particular image object, and
the content obtaining part causes the visual search to be performed for the processed or rotated image object.

8. The application supplying apparatus of claim 1, wherein the captured image is at least one of (i) a digital image of a real world scene and (ii) a digital image capturing a two-dimensional picture formed on a substantially flat surface of a structure.

9. The application supplying apparatus of claim 1, wherein the captured image is a digital image capturing a map of a predetermined area, and the image objects included in the captured image includes plural graphical objects corresponding to respective locations of the predetermined area.

10. The application supplying apparatus of claim 1, wherein said application supplied by said application supplying apparatus via the network to the user terminal further comprises
a usage tracking part that tracks and maintains usage data reflecting usage of the application on the user terminal, and wherein the additional content presented through the user interface is filtered or supplemented based on the usage data.

11. A mobile application including a program of instructions tangibly embodied in a non-transitory computer-readable medium and when executed by a computer comprises:
a user interface part that provides a user interface on the computer, to permit a user to invoke an image capture function to capture an image including one or more image objects, and add, as geo data associated with the captured image, location data indicating a current position of the computer as determined by a location determining function; and
a content obtaining part that, for each particular image object amongst said one or more image objects, (i) causes the particular image object to be extracted from the captured image and causes a visual search for the particular image object to be conducted in an image association database, to determine one or more associated items in the image association database that include image information matching the particular image object and that further include location information encompassing the geo data associated with the captured image, (ii) presents, for each particular item of the one or more associated items, content information which is registered in connection with the particular item in the image association database, through the user interface for user selection, and (iii) upon receiving the user selection through the user interface of said content information registered in connection with the particular item in the image association database, presenting, through the user interface, additional content corresponding to the content information.

12. The mobile application of claim 11, wherein the location determining function is a location determining application operating on the computer.

13. The mobile application of claim 11, wherein the image capture function is at least one of an image reading application and a camera application, operating on the computer.

14. The mobile application of claim 11, wherein
the mobile application executing on the computer is configured to communicate the captured image and the geo data through a network communication unit of the computer via a network with an external apparatus, to request the external apparatus to perform the visual search, and wherein
the mobile application executing on the computer is configured to receive from the external apparatus the content information which is registered in connection with the particular item in the image association database and is retrieved by the external apparatus from the image association database, and to cause the user interface to present the content information for user selection.

15. The mobile application of claim 11, wherein
the additional content is stored by an external content source,
the content information which is registered in connection with the particular item in the image association database includes a resource locator to the additional content, and
upon the user selection through the user interface of said content information, the content obtaining part employs the resource locator to retrieve the additional content from the external content source.

16. A method for providing user access to additional content based on a captured image, the method comprising:
(a) providing a content access application through a network to a user terminal to provide a user interface on the user terminal, to permit a user at the user terminal to invoke an image capture function on the user terminal to capture an image including one or more image objects, and add, as geo data associated with the captured image, location data indicating a current position of the user terminal as determined by a location determining function on the user terminal;
(b) causing, for each particular image object amongst said one or more image objects, (i) the particular image object to be extracted from the captured image and (ii) a visual search for the particular image object to be conducted in an image association database, to determine one or more associated items in the image association database that include image information matching the particular image object and that further include location information encompassing the geo data associated with the captured image;
(c) transmitting, for each particular item of the one or more associated items, content information which is registered in connection with the particular item in the image association database, to the user terminal to be displayed to the user, by the content access application, through the user interface for user selection;
(d) receiving, through the user interface, the user selection of said content information registered in connection with the particular item in the image association database;
(e) requesting additional content corresponding to the user-selected content information from an external content source;
(f) receiving the additional content corresponding to the user-selected content information from the external content source; and
(f) transmitting the received additional content to the user terminal to be presented to the user.

17. The method of claim 16, further comprising:
causing an outline of the particular image object to be extracted from the image and processed;
comparing the processed outline of the particular image object to registered outlines in the image association database; and
determining the one or more associated items in the image association database which match the particular image object by comparing the processed outline of the particular image object with a registered outline of the one or more associated items in the image association database.

18. The method of claim 16, further comprising:
causing the captured image to be communicated to an external apparatus to trigger the external apparatus to (i) extract the particular image object from the captured image, (ii) perform the visual search for the particular image object in the image association database and (iii) return to the user terminal the content information which is registered in connection with the particular item in the image association database.

19. The method of claim 16, further comprising:
presenting at least one of (i) multimedia content including a video or (ii) a coupon for obtaining a product or a service at a discounted charge, to the user as the additional content.

20. The method of claim 16, further comprising:
receiving a digital image capturing a map of a predetermined area as the captured image; and
extracting plural graphical objects corresponding to respective locations of the predetermined area as the image objects.
